(19) United States
(12) Patent Application Publication
(10) Pub. No.: US 2012/0032843 A1
(43) Pub. Date: Feb. 9, 2012

(54) RELAY TAG, LOCATION COMPUTATION READER, CONTINUOUS INDOOR AND OUTDOOR REAL-TIME LOCATION TRACKING METHOD AND SYSTEM USING GLOBAL POSITIONING SYSTEM (GPS) SIGNAL AND WIRELESS COMMUNICATION

(75) Inventors: Heyung Sub Lee, Daejeon (KR); Kang Bok Lee, Daejeon (KR)

(73) Assignee: Electronics and Telecommunications Research Institute, Daejeon (KR)

(21) Appl. No.: 13/197,282

(22) Filed: Aug. 3, 2011

(30) Foreign Application Priority Data
Aug. 3, 2010 (KR) 10-2010-0074919
Oct. 26, 2010 (KR) 10-2010-0104882

(51) Int. Cl. G01S 19/48

(52) U.S. Cl. 342/357.31

(57) ABSTRACT

Disclosed is a relay tag, a location computation reader, and a continuous indoor and outdoor real-time location tracking method and system, which tracks locations of a plurality of target objects of location tracking with a plurality of relay tags, in real time, wherein a GPS satellite transmits a location information signal outdoors, a similar GPS signaler generates a location information signal indoors, and transfers the generated location information signal, the plurality of relay tags, attached to the plurality of target objects of location tracking, relay the location information signals by receiving the location information signals transferred from the GPS satellite and the similar GPS signaler, and a location computation reader receives the location information signals from each of the plurality of relay tags, and computes locations of the plurality of target objects of location tracking.

### CROSS-REFERENCE TO RELATED APPLICATIONS

This application claims the benefit of Korean Patent Application No. 10-2010-0074919 and of Korean Patent Application No. 10-2010-0104882, respectively filed on Aug. 3, 2010 and Oct. 26, 2010, in the Korean Intellectual Property Office, the disclosures of which are incorporated herein by reference.

### BACKGROUND

1. Field of the Invention

The present invention relates to a method of tracking indoor and outdoor locations in real time using a Global Positioning System (GPS) signal and a Radio Frequency Identification (RFID) wireless communication.

2. Description of the Related Art

The Global Positioning System (GPS) using a satellite, hereinafter referred to as the ‘GPS system’, has been developed as a location tracking technology used to identify a location of a mobile terminal or object. For example, the location tracking technology of the GPS system is being developed as a location identification system that may compute a location based on a GPS location information signal, a location tracking system using a mobile communication network, and the like. Also, the location tracking technology is used in various fields, such as location tracking of general vehicle, a port, a shipping business, and the like.

However, a method using the GPS technology, among location tracking technologies, may only be feasible outdoors, where a GPS satellite signal may be received, and has a disadvantage of being infeasible indoors or in other areas where the satellite signal may fail to be received.

Another method of the location tracking technology uses various short distance wireless communications. As a representative example, there is a method of computing a location using an RFID technology. The method of computing a location using the RFID technology is a method that simultaneously identifies a target object with a tag using at least three readers, measures distances between each of the readers and the tag, and tracks a location of the target object through triangulation of the distances. However, in this wireless identification technology, the tag may necessarily need to be recognized by the at least three readers for location tracking of the tag. Accordingly, when the tag is away from a particular area where each of the readers is installed, a problem arises in that the location of the tag may be impossible to be tracked.

In addition, various methods that may compute a location using an ultra-wideband (UWB) technology, and a wireless local area network (WLAN) technology which is known as WiFi has been suggested. However, due to problems such as a limited usage, restraints occurring according to environments, a difference in application schemes for indoors and outdoors), and the like, those methods may be unapplied to all types of environments as a core technology.

Accordingly, there is a need for a technology that may provide real-time security continuity in an environment where mobility between heterogeneous networks is provided.

### SUMMARY

An aspect of the present invention provides a relay tag that may be implemented using low power and at a low cost, by simplifying a function of the tag attached to a target object of location tracking.

Another aspect of the present invention also provides a location computation reader that may compute a location of a target object of location tracking based on a location information signal received from a relay tag attached to the target object of location tracking, thereby enabling performance of more functions in a reader using a fixed power source, instead of the relay tag.

Still another aspect of the present invention also provides a continuous indoor and outdoor real-time location tracking method and system that may continuously perform real-time location tracking using the same relay tag, regardless of indoor and outdoor locations of a target object of location tracking, by applying the same location tracking method to a relay tag positioned outdoors, and a relay tag positioned indoors.

According to yet another aspect of the present invention, there is provided a continuous indoor and outdoor real-time location tracking system, including a Global Positioning System (GPS) satellite to transmit a location information signal outdoors, a similar GPS signaler to generate a location information signal indoors in a form similar to the GPS satellite, and to transfer the generated location information signal, and a plurality of relay tags, attached to a plurality of target objects of location tracking, to relay the location information signals by receiving the location information signals transferred from the GPS satellite and the similar GPS signaler, and a location computation reader to receive the location information signals from each of the plurality of relay tags, and to compute locations of the plurality of target objects of location tracking.

The plurality of relay tags, positioned indoors and outdoors, may generate a signal frame including a tag identification (ID) and information received from each GPS satellite, in the transferred location information signals, and may transmit the generated signal frame to the location computation reader.

The location computation reader may receive the transmitted signal frame using a wireless communication scheme, identify each of the plurality of relay tags respectively using the tag ID included in the received signal frame, and compute locations of the plurality of target objects of location tracking based on information received from the relay tags.

According to further another aspect of the present invention, there is also provided a similar GPS signaler, including a location information generation module to configure a data frame of the similar GPS signaler including an ID of the signaler, in order to provide information regarding a current location in relation to an indoor location for installing the similar GPS signaler, a synchronization processing module to receive time information from a GPS satellite, or to synchronize time between similar GPS signalers using other different schemes, and a signal transmission module to transfer a received location information signal to a relay tag.

According to still another aspect of the present invention, there is also provided a relay tag, including a signal reception module to receive a location information signal from a GPS satellite, or a similar GPS signaler, a frame generation module to generate a signal frame including a tag ID, and information received from the GPS satellite or the similar GPS signaler, in the received location information signal, and a wireless communication transmission module to transmit the generated signal frame to a location computation reader.

The frame generation module may generate the signal frame including a satellite time, a GPS satellite ID, a similar GPS signaler ID, location information, and a tag ID, using the location information signal.

The wireless communication transmission module may transmit a carrier frequency to the location computation reader, by incorporating the generated signal frame into the carrier frequency.

According to still another aspect of the present invention, there is also provided a location computation reader, including a wireless communication reception radio frequency (RF) module to receive a location information signal from each of a plurality of relay tags, a baseband module to demodulate the received location information signal, and a location computation processing module to compute locations of the plurality of relay tags based on the demodulated location information signal.

Here, the baseband module may demodulate a signal frame received as the location information signal. The location computation reader may compute the locations of the plurality of relay tags based on time information and a tag ID of each of the plurality of relay tags, included in the demodulated signal frame. The location computation reader may further include a network interface module to transmit the computed locations to a central server.

The location computation reader may further include a GPS receiver function module for increasing efficiency and accuracy in location computation according to a GPS signal.

According to still another aspect of the present invention, there is also provided a continuous indoor and outdoor real-time location tracking method, including receiving, by a plurality of relay tags attached to each of a plurality of target objects of location tracking, location information signals from a Global Positioning System (GPS) satellite and a similar GPS signaler, reconfiguring the received location information signals as a signal frame to transmit the location information signals to a location computation reader, transmitting the reconfigured location information signals to the location computation reader, and computing locations of the plurality of target objects of location tracking based on the transferred location information signals.

According to still another aspect of the present invention, there is also provided a continuous indoor and outdoor real-time location tracking method, including setting a current location in relation to a location for installing a similar GPS signaler, receiving a location information signal from a Global Positioning System (GPS) satellite, and synchronizing time between similar GPS signalers.

According to still another aspect of the present invention, there is also provided a continuous indoor and outdoor real-time location tracking method, including receiving a location information signal from a Global Positioning System (GPS) satellite or a similar GPS signaler, generating a signal frame using the received location information signal, and transmitting the generated signal frame to a location computation reader.

According to still another aspect of the present invention, there is also provided a continuous indoor and outdoor real-time location tracking method, including receiving a location information signal from each of a plurality of relay tags, demodulating the received location information signal, and computing locations of the plurality of relay tags based on the demodulated location information signal.

### Effect

According to an aspect of exemplary embodiments of the present invention, since a relay tag attached to a target object of location tracking for continuous indoor and outdoor location tracking may not need to compute a location, the relay tag may be implemented using low power and at a low cost.

According to an aspect of exemplary embodiments of the present invention, a reader using a fixed power source may perform more functions instead of a relay tag, by computing a location of a target object of location tracking based on a location information signal received from the relay tag attached to the target object of location tracking, and accordingly the location may be computed more precisely.

According to an aspect of exemplary embodiments of the present invention, continuous real-time location tracking may be performed using a relay tag, regardless of indoor and outdoor locations of a target object of location tracking, by applying the same location tracking scheme to a relay tag positioned outdoors, and a relay tag positioned indoors.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating network connection of a continuous indoor and outdoor real-time location tracking system according to an embodiment of the present invention;

FIG. 2 is a diagram illustrating a similar Global Positioning System (GPS) signaler according to an embodiment of the present invention;

FIG. 3 is a diagram illustrating a relay tag according to an embodiment of the present invention;

FIG. 4 is a diagram illustrating a location computation reader according to an embodiment of the present invention; and

FIG. 5 is a flowchart illustrating a continuous indoor and outdoor real-time location tracking method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

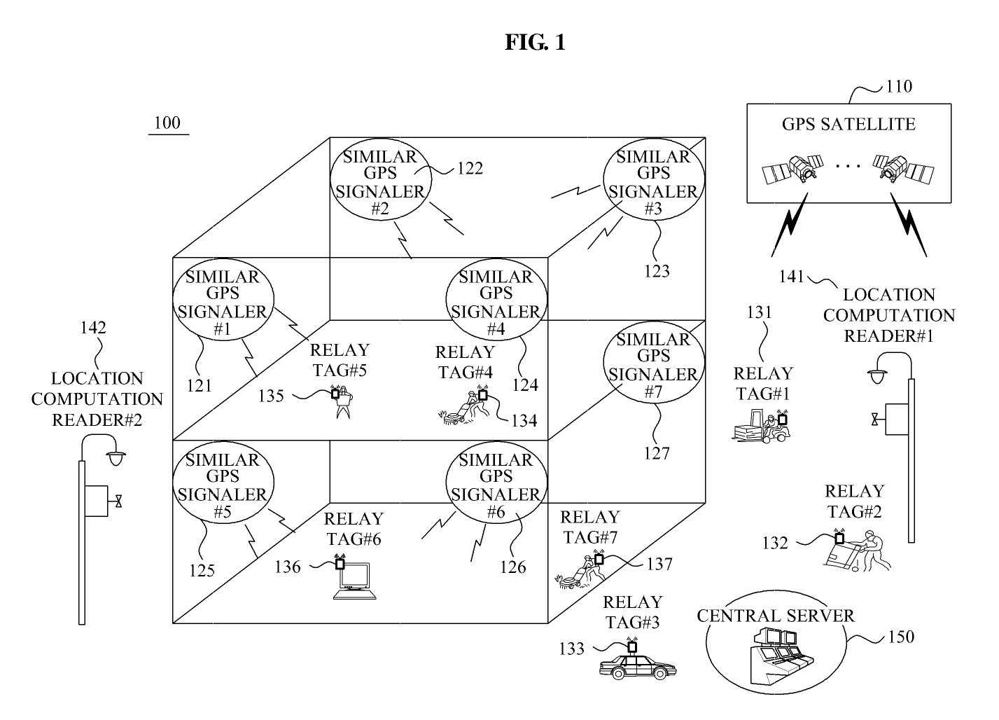

FIG. 1 is a diagram illustrating network connection of a continuous indoor and outdoor real-time location tracking system 100 according to an embodiment of the present invention.

Referring to FIG. 1, the continuous indoor and outdoor real-time location tracking system 100, hereinafter referred to as the ‘real-time location tracking system’, may include a Global Positioning System (GPS) satellite 100, and similar GPS signalers 121 through 127, relay tags 131 through 137, location computation readers 141 and 142, and a central server 150.

The GPS satellite 110 may transmit a location information signal to outdoor relay tags 131 through 133 in real time. Here, the location information signal may correspond to a signal used for computing a location of a target object of location tracking. The location may be precisely computed by measuring receiving time and distances from at least three GPS satellites, and by triangulating the at least three distances, each being different from one another. As an example, the target object of location tracking may correspond to a moving object, or a static object.

The similar GPS signalers 121 through 127 may generate a location information signal in a form similar to the GPS satellite 110 indoors, and may respectively transfer the generated location information signal to the plurality of indoor relay tags 134 through 137. For example, the similar GPS signalers 121 through 127 may transfer the location information signal to the indoor relay tags 134 through 137. Here, a transmission method employed by the similar GPS signalers 121 through 127 and the plurality of relay tags 134 through 137 may be identical to a transmission method employed by the GPS satellite 110 and the outdoor relay tags 131 through 133, or a GPS reception unit.

The plurality of relay tags 131 through 137 may be respectively attached to a plurality of target objects of location tracking, and may receive the transferred location information signal, and transmit the received location information signal to the location computation readers 141 and 142. The plurality of relay tags 131 through 137 may be positioned indoors or outdoors. For example, the relay tags 131 through 133 positioned outdoors may receive the location information signal from the GPS satellite 110, and the relay tags 134 through 137 positioned indoors may receive the location information signal from the similar GPS signalers 121 through 127.

The plurality of relay tags 131 through 137 may generate a signal frame including a tag identification (ID) and a difference in receiving time which may correspond to information received from each GPS satellite, in the transferred location signal, and may transmit the generated signal frame to the location computation readers 141 and 142. Accordingly, the plurality of relay tags 131 through 137 may be implemented using low power and at a low cost, by simplifying a function and by simply transmitting the received location information signal to the location computation readers 141 and 142 using a wireless communication scheme, instead of directly computing the location.

The location computation readers 141 and 142 may compute locations of the plurality of target objects of location tracking by receiving the location information signal from each of the plurality of relay tags 131 through 137. For example, the location computation readers 141 and 142 may receive the signal frame transmitted using the wireless communication scheme, respectively identify the plurality of relay tags 131 through 137 using the tag ID included in the received signal frame, and compute the locations of the target objects of location tracking by computing the locations of the plurality of the identified relay tags 131 through 137.

The location computation readers 141 and 142 may transmit the computed locations to the central server 150. Accordingly, the central server 150 may easily identify the locations of the target objects of location tracking that is, where the plurality of relay tags 131 through 137 may be attached, based on the computed locations.

Here, the wireless communication scheme is not limited to a specific scheme, and for example, a Radio Frequency Identification (RFID) scheme may be used.

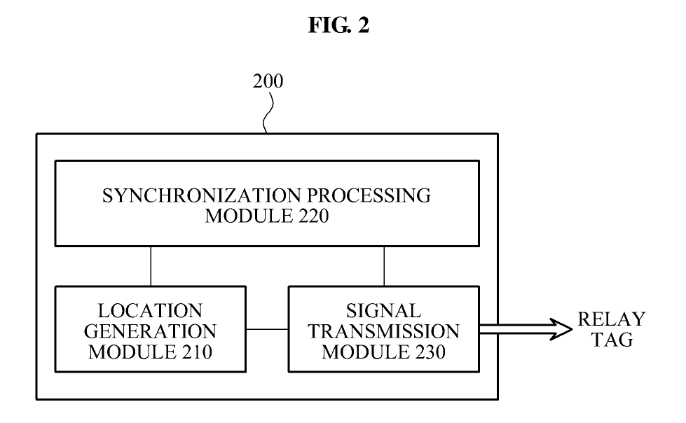

FIG. 2 is a diagram illustrating a similar GPS signaler 200 according to an embodiment of the present invention.

Referring to FIG. 2, the similar GPS signaler 200 may include a location information generation module 210, a synchronization processing module 220, and a signal transmission module 230.

The location information generation module 210 may configure a data frame of a similar GPS signaler, including an ID of the signaler in order to provide information regarding a current location, in relation to an indoor location, for installing the similar GPS signaler. The location information generation module 210 may set the current location by receiving an input of the current location from an administrator in relation to the location before the similar GPS signaler 200 is installed.

The synchronization processing module 220 may receive the time information from the GPS satellite 110, or synchronize time between similar GPS signalers using other different schemes.

The signal transmission module 230 may transfer the received location information signal to the plurality of indoor relay tags 134 through 137.

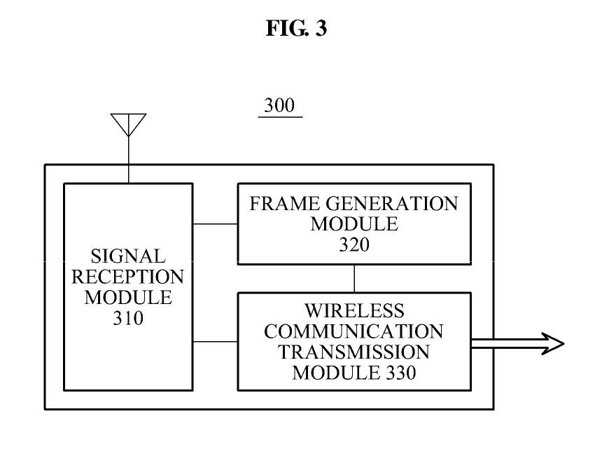

FIG. 3 is a diagram illustrating a relay tag 300 according to an embodiment of the present invention.

Referring to FIG. 3, the relay tag 300 may include a signal reception module 310, a frame generation module 320, and a wireless communication transmission module 330.

The signal reception module 310 may receive a location information signal from the GPS satellite 110 or a similar GPS signaler 200. Here, the relay tag 300 may be positioned indoors and outdoors. For example, when the relay tag 300 is positioned outdoors, the signal reception module 310 may receive the location information signal from the GPS satellite 110. When the relay tag 300 is positioned indoors, the signal reception module 310 may receive the location information signal from the similar GPS signaler 200.

The frame generation module 320 may generate a signal frame using the received location information signal. For example, the frame generation module 320 may generate the signal frame including a satellite time, a GPS satellite ID, a similar GPS signaler ID, location information, and a tag ID, using the location information signal. The satellite time and the location information may be obtained from the location information signal. The tag ID may correspond to an ID of the relay tag 300, which may be helpful for the location computation readers 141 and 142 to identify the location of the relay tag 300. Also, the frame generation module 320 may perform signal modulation on the generated signal frame to conform to the RFID scheme.

The wireless communication transmission module 330 may transmit the generated signal frame to the location computation readers 141 and 142. That is, the wireless communication transmission module 330 may transmit the generated signal frame to the location computation readers 141 and 142, by incorporating the generated signal frame into a cyclic redundancy check (CRC) carrier frequency.

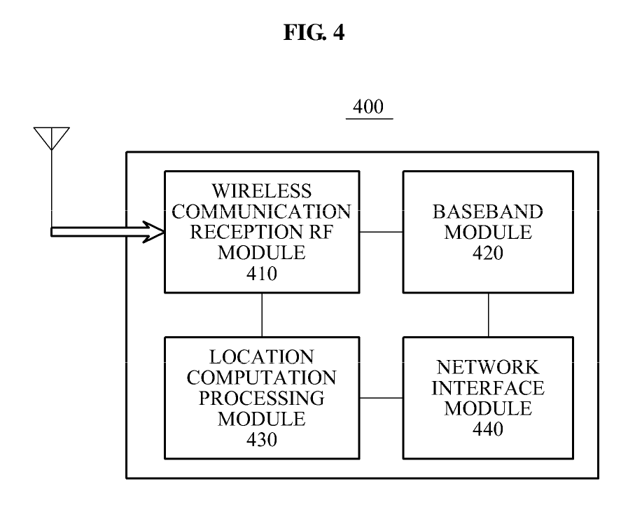

FIG. 4 is a diagram illustrating a location computation reader 400 according to an embodiment of the present invention.

Referring to FIG. 4, the location computation reader 40 may include a wireless communication reception RF module 410, a baseband module 420, a location computation processing module 430, and a network interface module 440. The wireless communication reception RF module 410 may receive a location information signal from each of the plurality of relay tags 131 through 137. In this instance, the wireless communication reception RF module 410 may receive a signal frame as the location information signal using a wireless communication scheme.

Here, the baseband module 420 may demodulate the received location information signal. That is, the baseband module 420 may demodulate the signal frame received as the location information signal. The signal frame may be modulated by the relay tags 131 through 137, and incorporated into a carrier frequency before being transmitted, and accordingly the signal frame may need to be demodulated. For example, the baseband module 420 may identify a satellite time, a GPS satellite ID, a similar GPS signaler ID, location information, and tag IDs of each of the relay tags 131 through 137, from the signal frame.

The location computation processing module 430 may compute the locations of the plurality of relay tags 131 through 137 based on the demodulated location information signal. For example, the location computation processing module 430 may compute the locations of the plurality of relay tags 131 through 137 based on a location and a tag ID of each of the relay tags, through the satellite time, the GPS satellite ID, the similar GPS signaler ID, the location information, included in the demodulated signal frame.

The network interface module 440 may transmit the computed locations to the central server 150. That is, the network interface module 440 may provide an interface that may provide the computed locations to the central server 150, thereby enabling various types of application services.

Also, the location computation reader 400 may include a GPS receiver function module in order to increase efficiency and accuracy of location computation according to the GPS signal.

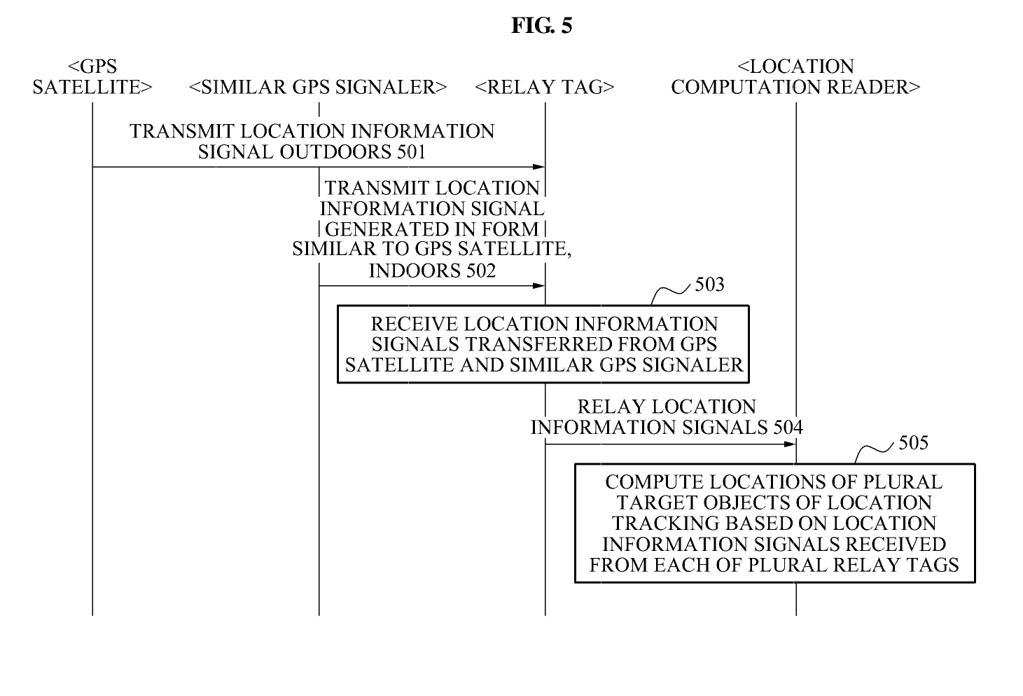

FIG. 5 is a flowchart illustrating a continuous indoor and outdoor real-time location tracking method according to an embodiment of the present invention.

Referring to FIG. 5, in operation 501, the GPS satellite 110 may transmit a location information signal to the relay tag 300 outdoors, in real time. Here, the location information signal may correspond to a signal used for computing a location of a target object of location tracking. In this instance, the location may be precisely computed by measuring time and distances received from at least three GPS satellites, and by triangulating the at least three distances, each being different from one another. As an example, the target object of location tracking may correspond to a moving object, or a static object.

In operation 502, the similar GPS signaler 200 may generate a location information signal in a form similar to the GPS satellite 110 indoors, and may transfer the generated location information signal to the relay tag 300. For example, the similar GPS signaler 200 may transfer the location information signal to the relay tag 300 positioned indoors.

In operation 503, the relay tag 300 may be attached to each of a plurality of target objects of location tracking, and may receive the location information signals transferred from the GPS satellite 100 and the similar GPS signaler 200.

For example, the relay tag 300 may generate a signal frame including a tag ID and a difference in receiving time, in the location information signals. When the relay tag 300 is positioned outdoors, the relay tag 300 may receive the location information signal from the GPS satellite 110. When the relay tag 300 is positioned indoors, the relay tag 300 may receive the location information signal from the similar GPS signaler 200.

In operation 504, the relay tag 300 may relay the received location information signals to the location computation reader 400. Accordingly, the relay tag 300 may be implemented using low power and at a low cost, by simplifying a function and by simply transmitting the received location information signals to the location computation reader 400 using a wireless communication scheme, instead of directly computing the location.

In operation 505, the location computation reader 400 may compute locations of the plurality of target objects of location tracking based on the location information signals received from the relay tag 300. For example, the location computation reader 400 may identify the tag 300 using the tag ID included in the signal frame received as the location information signals, and may compute the locations of the target objects of location tracking by computing the location of the identified relay tag 300.

The location computation reader 400 may transmit the computed locations to the central server 150. Accordingly, the central server 150 may easily identify the locations of the target objects of location tracking that is, where the plurality of relay tags 131 through 137 may be attached, based on the computed locations.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A continuous indoor and outdoor real-time location tracking system, comprising:
a Global Positioning System (GPS) satellite to transmit a location information signal outdoors;
a similar GPS signaler to generate a location information signal indoors in a form similar to the GPS satellite, and to transfer the generated location information signal;
a plurality of relay tags, attached to a plurality of target objects of location tracking, to relay the location information signals by receiving the location information signals transferred from the GPS satellite and the similar GPS signaler; and
a location computation reader to receive the location information signals from each of the plurality of relay tags, and to compute locations of the plurality of target objects of location tracking.

2. The system of claim 1, wherein the plurality of relay tags, positioned indoors and outdoors, generates a signal frame including a tag identification (ID) and information received from each GPS satellite, in the transferred location information signals, and transmits the generated signal frame to the location computation reader.

3. The system of claim 2, wherein the location computation reader receives the transmitted signal frame using a wireless communication scheme, identifies each of the plurality of relay tags respectively using the tag ID included in the received signal frame, and computes locations of the plurality of target objects of location tracking based on information received from the relay tags.

4. A similar Global Positioning System (GPS) signaler, comprising:
a location information generation module to configure a data frame of the similar GPS signaler including an identification (ID) of the signaler, in order to provide information regarding a current location in relation to an indoor location for installing the similar GPS signaler;
a synchronization processing module to receive time information from a GPS satellite, or to synchronize time between similar GPS signalers using other different schemes; and
a signal transmission module to transfer a received location information signal to a relay tag.

5. A relay tag, comprising:
a signal reception module to receive a location information signal from a Global Positioning System (GPS) satellite, or a similar GPS signaler;
a frame generation module to generate a signal frame including a tag identification (ID), and information received from the GPS satellite or the similar GPS signaler, in the received location information signal; and
a wireless communication transmission module to transmit the generated signal frame to a location computation reader.

6. The relay tag of claim 5, wherein the frame generation module generates the signal frame including a satellite time, a GPS satellite ID, a similar GPS signaler ID, location information, and a tag ID, using the location information signal.

7. The relay tag of claim 5, wherein the wireless communication transmission module transmits a carrier frequency to the location computation reader, by incorporating the generated signal frame into the carrier frequency.

8. A location computation reader, comprising:
a wireless communication reception radio frequency (RF) module to receive a location information signal from each of a plurality of relay tags;
a baseband module to demodulate the received location information signal; and
a location computation processing module to compute locations of the plurality of relay tags based on the demodulated location information signal.

9. The location computation reader of claim 8, further comprising:
a network interface module to transmit the computed locations to a central server,
wherein the baseband module demodulates a signal frame received as the location information signal, and
the location computation processing module computes the locations of the plurality of relay tags based on a location and a tag identification (ID) of each relay tag, included in the demodulated signal frame.

10. The location computation reader of claim 8, further comprising:
a GPS receiver function module for increasing efficiency and accuracy in location computation according to a GPS signal.

11. A continuous indoor and outdoor real-time location tracking method, comprising:
receiving, by a plurality of relay tags respectively attached to a plurality of target objects of location tracking, location information signals from a Global Positioning System (GPS) satellite and a similar GPS signaler;
reconfiguring the received location information signals as a signal frame to transmit the location information signals to a location computation reader;
transmitting the reconfigured location information signals to the location computation reader; and
computing locations of the plurality of target objects of location tracking, based on the transferred location information signals.

12. The method of claim 12, wherein the reconfiguring comprises reconfiguring, by the plurality of relay tags, positioned indoors and outdoors, the received location information signals as the signal frame, including a tag identification (ID), and information received from each GPS satellite, in order to transmit the location information signals to the location computation reader.

13. The method of claim 11, wherein the computing comprises:
receiving the transmitted signal frame using a wireless communication scheme;
respectively identifying the plurality of relay tags that transmits the signal frame using a tag identification (ID) included in the received signal frame; and
computing locations of the target objects of location tracking, by computing locations of the identified relay tags.

14. A continuous indoor and outdoor real-time location tracking method, comprising:
setting a current location in relation to a location for installing a similar GPS signaler;
receiving a location information signal from a Global Positioning System (GPS) satellite; and
synchronizing time between similar GPS signalers.

15. A continuous indoor and outdoor real-time location tracking method, comprising:
receiving a location information signal from a Global Positioning System (GPS) satellite or a similar GPS signaler;
generating a signal frame using the received location information signal; and
transmitting the generated signal frame to a location computation reader.

16. The method of claim 15, wherein the generating comprises generating the signal frame including a satellite time, a GPS satellite identification (ID), a similar GPS signaler ID, location information, and a tag ID, using the location information signal.

17. The method of claim 15, wherein the transmitting comprises transmitting a carrier frequency to the location computation reader, by incorporating the generated signal frame into the carrier frequency, using a wireless communication scheme.

18. A continuous indoor and outdoor real-time location tracking method, comprising:
receiving a location information signal from each of a plurality of relay tags;
demodulating the received location information signal; and
computing locations of the plurality of relay tags based on the demodulated location information signal.

19. The method of claim 18, wherein
the demodulating comprises demodulating a signal frame received as the location information signal, and
the computing comprises:
computing the locations of the plurality of relay tags based on a location and a tag identification (ID) of each relay tag, included in the demodulated signal frame; and
transmitting the computed location to a central server.
